(19) United States
(12) Patent Application Publication
(10) Pub. No.: US 2003/0002283 A1
(43) Pub. Date: Jan. 2, 2003

(54) Four tube compact fluorescent lamp

(76) Inventors: Daniel Marian, Gardiner, NY (US); Robert Y. Pai, Hamilton, MA (US); Steven C. Farley, Montgomery, NY (US); Albert Cavallaro, Florida, NY (US)

Correspondence Address: William H. McNeil, OSRAM SYLVANIA Inc., 100 Endicott Street, Danvers, MA, 01923, US

(21) Appl. No.: 09/898,546

(22) Filed: Jul. 2, 2001

(51) Int. Cl. F21K 2/00

(52) U.S. Cl. 362/260; 362/252; 362/216

(57) ABSTRACT

A compact fluorescent lamp comprises four dual tube segments affixed to a base having a planar surface. Each of the segments extends in a direction away from the planar surface and is arranged in a plan wherein one of the tubes of each of the four dual tube segments is positioned at the corner of a square. This configuration reduces the wasted area in the center of the base and provides a smaller base thus allowing application of the lamp in areas previously not accessible.

### TECHNICAL FIELD

This application relates to compact fluorescent lamps and more particularly to such lamps having a reduced area with no decrease in light output, thus allowing placement of the lamps in locations previously adapted only for smaller lamps with less light output.

### BACKGROUND ART

Compact fluorescent lamps are generally considered to be lamps designed for the direct replacement of ordinary household incandescent lamps: that is, those incandescent lamps having wattage ranges between 40 and 150 watts. Replacement lamps of the compact fluorescent variety often have power consumption in the range of 7 to about 22 watts with similar light output and considerable power savings. Additionally, the compact fluorescent lamps often have extended life expectancies when compared to the ordinary incandescent lamps (10,000 hours compared to 2,000 hours for long life incandescent).

These compact fluorescent lamps may have a spiral configuration but are usually comprised of one or more segments of dual tubes configured as an elongated U. This invention is particularly concerned with the latter type of compact fluorescent and still more particularly with that type of lamp composed of 4 U-shaped segments. Current lamps of the latter type have had the U-shaped segments extending from a base and positioned on the sides of a square, leaving a large amount of wasted space in the center of the base and eliminating use of the lamp in a number of confined areas.

### DISCLOSURE OF INVENTION

It is therefore, an object of the invention to obviate the disadvantages of the prior art.

It is another object of the invention to enhance the use of compact fluorescent lamps.

Yet another object of the invention is the provision of a compact fluorescent lamp having improved adaptability.

These objects are accomplished, in one aspect of the invention, by a compact fluorescent lamp that comprises four dual tube segments affixed to a base having a planar surface. Each of the segments extends in a direction away from the planar surface and is arranged in a plan wherein one of the tubes of each of the four dual tube segments is positioned at the comer of an imaginary square. This configuration reduces the wasted area in the center of the base and provides a smaller base thus allowing application of the lamp in areas previously not accessible. To accomplish a similar result previously it was necessary to reduce the size of the tubes making up the lamp and thereby reducing the light output.

### BRIEF DESCRIPTION OF THE DRAWINGS

FIG. 1 is a diagrammatic plan view of a prior art compact fluorescent lamp having four dual tube segments; and

FIG. 2 is a similar of a lamp embodying the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

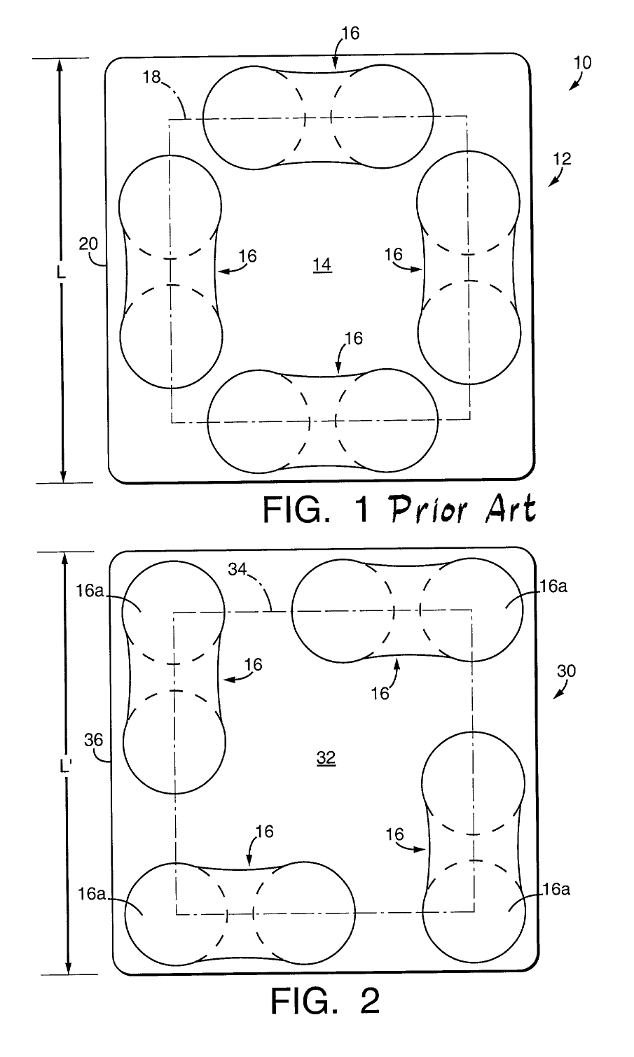

Referring now to the drawings with greater particularity, there is shown in FIG. 1 the layout of a prior art compact fluorescent lamp 10 having a base 12, which includes a planar surface 14. The lamp 10 comprises four dual tube segments 16 arranged along the sides of a square 18, shown in phantom lines. This arrangement produces a base 12 having sides 20 with a length L. Such lamps are known in the art as shown in U.S. Pat. Nos. 5,541,477 and 6,005,337. While these lamps function well, they are limited in use because their large size base precludes their use in many applications. For example, to replace an ordinary incandescent lamp it is necessary for the compact fluorescent to fit within the harp. In many instances this is not possible because of the size of the compact fluorescent lamp. Prior solutions have simply utilized smaller tube fluorescents with, of course, diminished light output.

The solution provided by this invention is shown in FIG. 2 wherein a lamp 30 comprises four dual tube segments 16 identical to those of the prior art lamp 10. However, in lamp 30 each of the segments extends in a direction away from a planar surface 32 and is arranged in a plan wherein one of the tubes, for example, 16a, of each of the four dual tube segments 16 is positioned at the corner of a square 34. This configuration reduces the wasted area in the center of the base and provides a smaller base thus allowing application of the lamp in areas previously not accessible. To accomplish a similar result previously it was necessary to reduce the size of the tubes making up the lamp and thereby reducing the light output.

Lamps constructed according to the teachings provided herein can have tubes of T4 size, which, with a typical amalgam filling, will produce a light output of 4000 lumens with a color rendering index of 82. These lamps have a life expectancy of 12,000 hours. Further, lamps so produced have a sides 36 having a length L′ which is less than the length L of the prior art lamps.

This space saving allows the lamp of the invention to be used in a greater variety of locations than the prior art lamps and yet provides a lamp having greater light output than previously smaller lamps.

While there have been shown and described what are at present considered the preferred embodiments of the invention, it will be apparent to those skilled in the art that various changes and modifications can be made herein without departing from the scope of the invention as defined by the appended claims.

What is claimed is:

1. A compact fluorescent lamp comprising: four dual tube segments affixed to a base having a planar surface, each of said segments extending in a direction away from said planar surface and arranged in a plan wherein one of the tubes of each of said four dual tube segments is positioned at the comer of an imaginary square.

2. The compact fluorescent lamp of claim 1 wherein each of said tubes of each of said dual tube segments has a diameter of 4/8 inches.

3. The compact fluorescent lamp of claim 1 wherein said lamp has a life expectancy of 12,000 hours.

4. The compact fluorescent lamp of claim 1 wherein said lamp has a light output of about 4000 lumens and a color rendering index of 82.
